(19) United States
(12) Patent Application Publication
(10) Pub. No.: US 2026/0138850 A1
(43) Pub. Date: May 21, 2026

(54) TRANSPORT SYSTEM WITH VERTICAL AND HORIZONTAL TRANSPORT SUBSYSTEMS

(71) Applicant: INVENTIO AG, Hergiswil (CH)

(72) Inventors: Christian Studer, Kriens (CH); Florian Troesch, Erlenbach (CH); Eliza Olczyk, Horw (CH); Lukas Finschi, Ebikon (CH)

(21) Appl. No.: 19/121,419

(22) PCT Filed: Dec. 12, 2023
(86) PCT No.: PCT/EP2023/085364

§ 371 Date: Apr. 15, 2025

(30) Foreign Application Priority Data
Dec. 19, 2022 (EP) 22214491.7

(51) Int. Cl. B66B 9/00; B66B 1/24

(52) U.S. Cl. CPC B66B 9/003; B66B 1/2408; B66B 2201/103

(57) ABSTRACT

An integrated transport system in a building includes an elevator system and a vehicle system which are communicatively coupled to a control system. The elevator system has an elevator having an elevator car and an elevator controller configured to cause the elevator car to move between floors of the building. The vehicle system has a vehicle provided and movable on a floor served by the elevator system, wherein the vehicle is configured to serve an elevator hall on the floor. The control system is configured to process a travel request from a call terminal usable for entering the travel request which specifies a place of departure and a destination, to calculate a trip schedule based on the travel request, the trip schedule involving the elevator system and the vehicle system, and to control the elevator system and the vehicle system according to the trip schedule.

This disclosure generally relates to transporting passengers in horizontal and vertical directions. More particularly, the disclosure relates to horizontally and vertically transporting passengers in a building.

An elevator system in which an elevator car moves in horizontal and vertical directions is disclosed in EP 3 448 792B1. The elevator system is referred to as a multi-axis, multi-car, multi-route elevator system which provides for multiple elevator cars in a single shaft and allows taking multiple, alternative routes to reach the same destination. The elevator system includes a graphical destination interface for displaying an isometric rendering of at least a portion of the building and a plurality of destinations. A passenger can select from several displayed elevator call request options, such a shortest route in distance traveled to a final destination, a route with the shortest time to destination, a route that departs the quickest or has the quickest estimated time of arrival, and a route with the shortest riding time.

This elevator system requires switches to guide the elevator car in horizontal and vertical directions. While delays resulting from one or more changes in the travel direction may not be an issue in relatively complex buildings, e. g., because passenger convenience outweighs the delays, in other buildings such delays may be less acceptable. There is, therefore, a need for a technology that provides for transporting passengers in horizontal and vertical directions with reduced delays and, hence, in a more convenient way.

Accordingly, one aspect involves an integrated transport system in a building. The integrated transport system includes an elevator system and a vehicle system which are communicatively coupled to a control system. The elevator system has at least one elevator having an elevator car and an elevator controller configured to cause the elevator car to move between floors of the building. The vehicle system has at least one vehicle provided and movable on a floor served by the elevator system. The vehicle is configured to serve an elevator hall on the floor. The control system is configured to process a travel request from a call terminal usable for entering the travel request which specifies a place of departure and a destination, to calculate a trip schedule based on the travel request, the trip schedule involving the elevator system and the vehicle system, and to control the elevator system and the vehicle system according to the trip schedule.

Another aspect involves a method of operating an integrated transport system having an elevator system and a vehicle system which are communicatively coupled to a control system. The elevator system has at least one elevator having an elevator car and an elevator controller configured to cause the elevator car to move between floors of a building. The vehicle system has a vehicle system having at least one vehicle provided and movable on a floor served by the elevator system, wherein the least one vehicle is configured to serve an elevator hall on the floor. The method includes receiving a travel request from a call terminal and calculating a trip schedule based on the travel request. The travel request specifies a place of departure and a destination, and the trip schedule involves the elevator system and the vehicle system. Further, the method includes controlling the elevator system and the vehicle system according to the trip schedule.

The technology described herein provides for an integrated transport system wherein its transport subsystems, e. g., the elevator system and the vehicle system, are centrally controlled by the control system. The transport of a passenger or a robot in horizontal and vertical directions takes place according to the trip schedule generated by the control system. In that trip schedule, individual trip portions are allocated to the elevator system and the vehicle system, and coordinated to provide for a faster and more convenient trip. For example, a passenger may consider the trip as being essentially seamless because upon completing an intermediate trip portion using one transport mode (e. g., the elevator system) the transport mode (e. g., a vehicle) for the next trip portion is already available and waiting, or about to be available, for boarding.

In one embodiment, which may be combined with any of the described embodiments, the integrated transport system includes a database stored in a storage system configured for read and write operations by the control system. The database stores data of a building plan, wherein the building plan data specifies for each floor at least locations of at least one of elevator halls, residences, establishments, call terminals, doors, access gates, escalators, emergency exits or routes, and main building entrances, routes and lanes to these locations, and distances between these locations. This allows determining a suitable path to serve the travel request, i. e., to transport the passenger or robot from the place of departure to the destination. Maintaining this information and data in the database facilitates reading the information and data and updating it if necessary.

In one embodiment of the integrated transport system, which may be combined with any of the described embodiments, the control system includes a location and status determining unit coupled to the elevator system and the vehicle system and configured to determine a location and a status of the at least one elevator and the at least one vehicle. Hence, the location and status determining unit collects real-time information from the elevator system and the vehicle system which is then used to plan a trip.

In one embodiment of the integrated transport system, which may be combined with any of the described embodiments, the control system includes a trip planning unit coupled to the location and status determining unit, the elevator system and the vehicle system. The trip planning unit is configured to compute the trip schedule based on the travel request and a location and a status of the at least one elevator and the at least one vehicle determined by the location and status determining unit. The information available to the trip planning unit allows planning a trip for immediate execution or for execution at a later time, e. g., in case for a passenger (or a robot) a trip is planned for the next day, certain transport modes can be reserved for that trip.

In one embodiment, which may be combined with any of the described embodiments, the call terminal is installed on a floor of the building. One or more floor terminals may be installed on each floor served by the transport system. A call terminal may be a mobile phone carried by a passenger, or a radio communications device of a robot. The technology described herein allows that the number and types of call terminals can be adapted to the building and its needs.

In one embodiment, which may be combined with any of the described embodiments, the control system is configured to send the trip schedule to the call terminal from which the control system received the travel request. The trip schedule provides advance information about when and where to start the trip and which transport mode(s) to use.

In one embodiment, which may be combined with any of the described embodiments, the transport system includes a camera system coupled to the control system and having a plurality of cameras arranged on the floors. The control system is configured to monitor a movement of a passenger to determine if the passenger is transported according to the trip schedule, and to generate an alarm signal in case a deviation from the trip schedule is detected. This prevents that system efficiency decreases due to transport modes allocated for the trip not being used; it also reduces the risk of delaying the trip because, e. g., the passenger is transported to a wrong destination.

In one embodiment, which may be combined with any of the described embodiments, the transport system, the control system is configured to initiate at least one mitigating measure in response to the alarm signal. The at least one mitigating measure includes generating a notification for being communicated to the passenger, modifying the scheduled trip and/or controlling the elevator system and the vehicle system according to the modified scheduled trip. Hence, even if a deviation is detected, the technology described herein provides for measures that address the deviation to reduce the effects on the system's efficiency and the transport convenience.

At least some embodiments of the disclosed methods can be implemented using a computer or computer-based device that performs one or more method acts, the computer or computer-based device having read instructions for performing the method acts from one or more computer-readable storage media. The computer-readable storage media can comprise, for example, one or more optical disks, volatile memory components (such as DRAM or SRAM), and/or nonvolatile memory components (such as hard drives, Flash RAM or ROM). The computer-readable storage media do not cover pure transitory signals. The methods disclosed herein are not performed solely in the human mind.

In the following, various aspects of the improved technology are explained in more detail by means of exemplary embodiments in connection with the figures. All figures are merely schematic illustrations of methods and terminals or their components according to exemplary embodiments of the improved technology. In particular, distances and size relations are not reproduced to scale in the figures. In the figures, identical elements have identical reference signs. In the drawings:

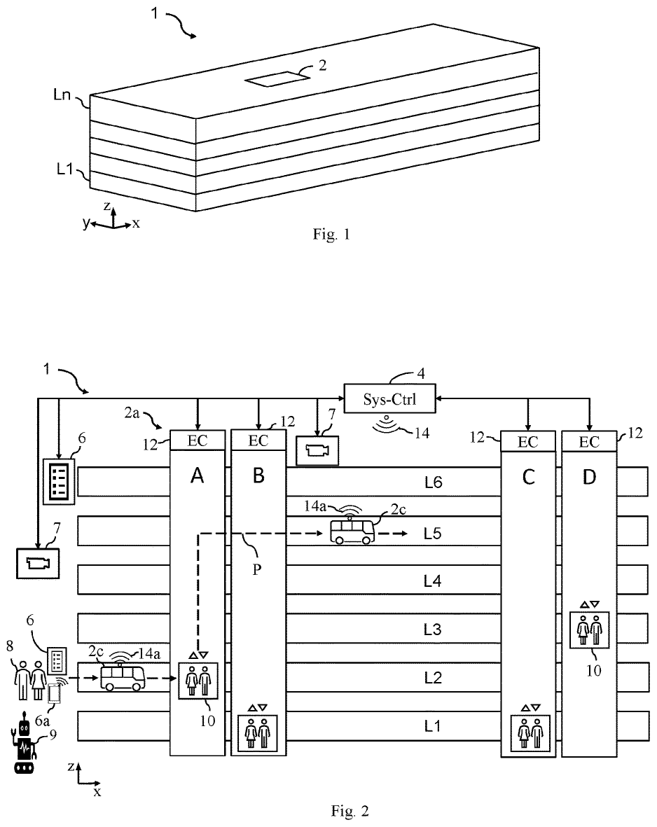

FIG. 1 shows a perspective illustration of an exemplary embodiment of a building having several floors;

FIG. 2 shows a schematic side view of the building of FIG. 1 with an exemplary embodiment of a transport system for transporting passengers;

FIG. 3 shows a block diagram of an exemplary embodiment of the transport system of FIG. 2;

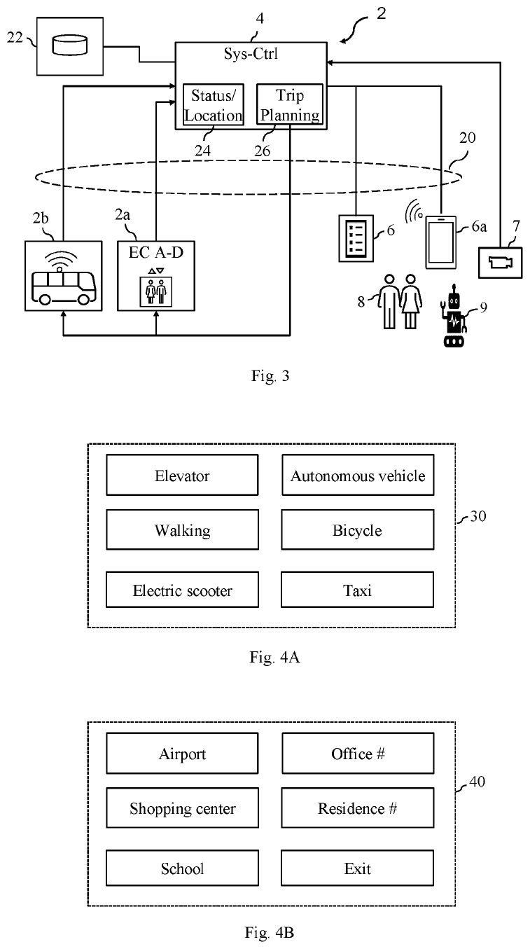

FIG. 4A shows exemplary depictions of transport modes;

FIG. 4B shows exemplary depictions of possible destinations;

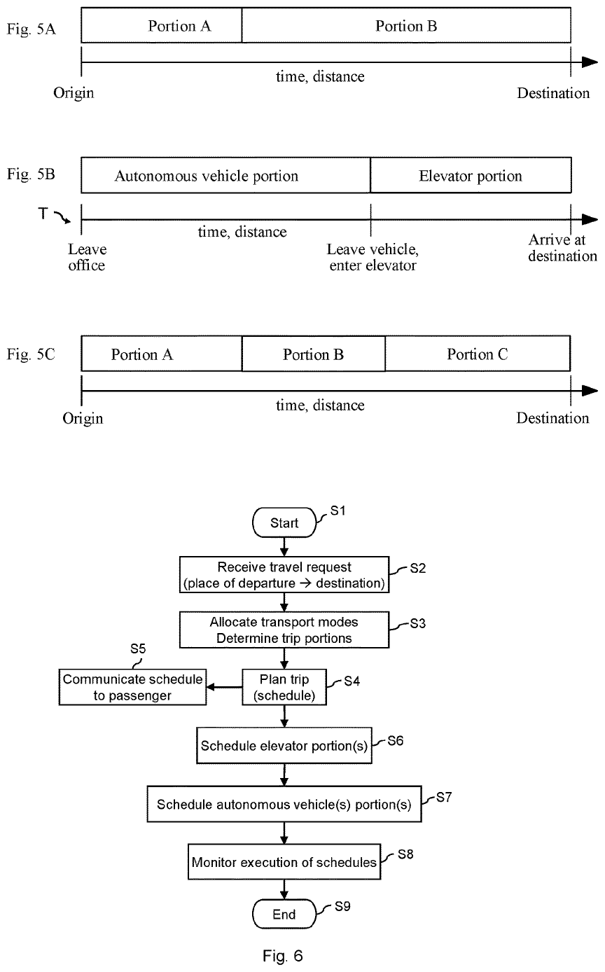

FIG. 5 shows a block diagram of an exemplary embodiment of a method of scheduling use of an elevator;

FIG. 6 shows a block diagram of an exemplary embodiment of a method of scheduling use of an elevator;

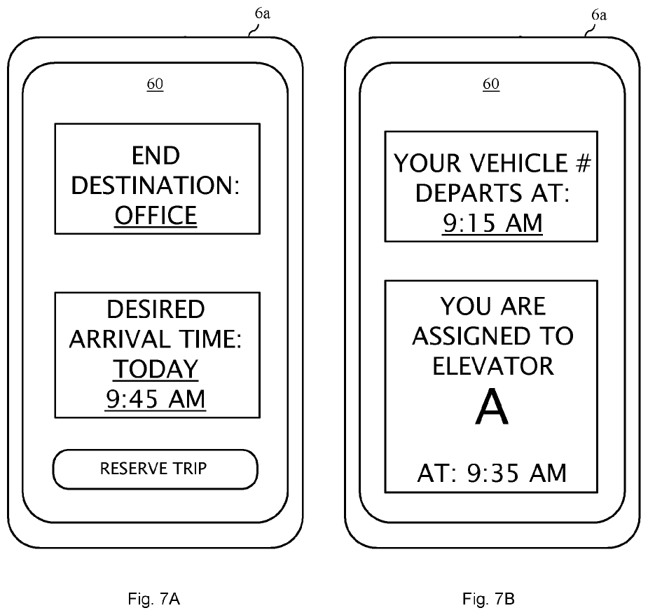

FIG. 7A shows an exemplary embodiment of an electronic device displaying a graphical user interface that can be used entering a travel request;

FIG. 7B shows an exemplary embodiment of the electronic device of FIG. 7A, wherein the graphical user interface displays travel information in response to the travel request.

FIG. 1 a shows a perspective illustration of an exemplary embodiment of a building 1 (which may house, e. g., residences, offices, hotels, retail spaces and/or other facilities) that has, with reference to a depicted x-y-z coordinate system, a length in direction of the x-axis (x-direction), a width in direction of the y-axis (y-direction) and a height in direction of the z-axis (z-direction). In z-direction, the building 1 has several floors L1, Ln (n=1, 2, . . . N, with N being the number of usable and/or serviceable floors), and in a plane defined by the x- and y-axes, i. e., horizontally, the building 1 has a predetermined expansion. In the embodiment of FIG. 1, the building 1 is longer than wide. Within the building 1, a transport system 2 is installed to provide for vertical and horizontal transportation of passengers and objects (e. g., robots). A need for such a horizontal transportation may be due to the building's horizontal expansion, e. g., in particular, in x-direction.

FIG. 2 shows a schematic side view of the building 1 having, for example, six floors L1, . . . L6. Within the building 1, an exemplary embodiment of the transport system 2 is installed to serve the building's floors L1, . . . , L6, e. g., to transport a passenger 8 from a place of departure on the floor L2 to a destination on the floor L5 along a travel path P, as illustrated in FIG. 2 in dashed lines. The transport system 2 includes as subsystems an elevator system 2a, which provides for a vertical transportation, and a vehicle system 2b, which provides for a horizontal transportation in the plane defined by the x-and y-axes. In the embodiment of FIG. 2, the horizontal transportation occurs along the x-axis, without being limited to that direction. The transport system 2 includes a control system 4 (Sys-Ctrl) that controls the subsystems, e. g., both the elevator system 2a and the vehicle system 2b. For illustrative purposes, passengers 8 and a robot 9 are shown, however, embodiments described hereinafter refer to one or more passengers 8. It is contemplated that the embodiments may apply correspondingly to the robot 9, which may be equipped with a radio communications device for communicating with the transport system 2, e. g, to communicate a travel request and to receive transport instructions.

Within the building 1, at least one, e. g., cuboidal space or volume is provided for positioning some components of the elevator system 2a and allowing an elevator car 10 to move in the vertical direction between the floors L1, . . . , L6. At each floor L1, . . . , L6 provisions are made to allow passengers 8 to board and deboard the elevator car 10 (e. g., elevator lobbies or landings, shaft or hoistway doors). Hereinafter, such a (cuboidal) space or volume may be referred to as a shaft, which may at least partially be confined by building walls. In one embodiment, the shaft may be adapted for a so-called panoramic elevator. The elevator system 2a may have more than one elevator car 10 that move in the same shaft, or an elevator car 10 may be configured as a multiple-deck car (e. g., a double-deck car).

Elevator systems, including their various configurations and control technologies, are known to a person skilled in the art. Known configurations include, for example, traction elevator systems and hydraulic elevator systems. Such elevator systems may be equipped with a call control technology that allows a passenger on a boarding floor to enter a desired travel direction (up/down), and, after boarding the elevator car, to enter the destination floor. Other elevator systems may be equipped with a call control technology that allows a passenger on a boarding floor to enter a desired destination floor, such technology is also referred as a destination call control system. One example of an elevator system equipped with a destination call control system is a Schindler 7000 elevator system with the Schindler PORT Technology. The destination call control system is based on a call allocation algorithm whose principle is generally described in Koehler, Jana, et al., An AI-Based Approach to Destination Control in Elevators, AI Magazine, Vol. 23, Nr. 3, 2002, S. 59-78. The allocation algorithm applies the concept of “cost” and uses one or more cost functions to determine an elevator car best suited to serve an elevator call. In this disclosure, the various embodiments are described with reference to the destination call control system.

In the embodiment shown in FIG. 2, the elevator system 2a includes four elevators A, B, C, D, which are divided in two groups (A, B and C, D), without being limited to such a grouping. The two groups are shown as being spaced from each other, wherein for certain travel requests the transport system 2b may be used to transport passengers 8, goods, or robots 9 between the two groups, as illustrated in FIG. 2. The skilled person will recognize that in another embodiment the elevator system 2a may include less than four elevators, e. g., only one, or more than four elevators. Depending on the building's horizontal expansion the elevator system 2a may include more than two groups.

Each elevator A, B, C, D includes an elevator car 10 and is controlled by an elevator controller 12 (EC). The elevator controllers 12 are communicatively coupled to the control system 4 which performs the above-mentioned allocation algorithm to determine the elevator A, B, C, D that serves a travel request. Among other functions, each elevator controller 12 controls the up and down movements of its elevator car 10. These functions are known to the skilled person.

The control system 4 is further communicatively coupled to call terminals 6, 6a passengers can use to request a transport service, e. g., to a desired destination. The call terminals 6 may be installed on the floors L1, . . . Ln in public zones (e. g., hallways or lobbies) and/or nonpublic (private) zones (e. g., apartments or offices). Entry of a request may require a passenger 8 to present an RFID (radio-frequency identification) card, a magnetic storage device (e. g., magnetic strip cards); and/or an optical code device, e. g., for identification and/or authentication purposes. These installed terminals 6 are illustrated in FIG. 2 as floor terminals displaying, e. g., a selection of possible destinations within the building 1. In addition, portable mobile devices, e. g., mobile (smart)phones, may be configured to execute a dedicated software application (app) and serve as mobile call terminals 6a, which are illustrated in FIG. 2 as mobile communications devices such as mobile phones.

Referring to the vehicle system 2b, on at least some of the floors L1, . . . , Ln at least one lane (track, road, or corridor) may be provided for a vehicle 2c to move in horizontal direction. In FIG. 2, such a lane extends in x-direction, it may, however, also extend in y-direction or in x-and y-directions. The lane may be reserved exclusively for the vehicle 2a. FIG. 2 shows vehicles 2c on floors L2 and L5. Depending on the building 1, e. g., regarding size, distances to bridge and/or use, the vehicles 2c may be railed vehicles, in which case the lane includes rails, or road vehicles, in which case the lane may be road like. Irrespective of their configuration, the vehicles 2c may be driverless and configured to transport one or more passengers 8, goods and robots 9. In some embodiments, the vehicles 2c may be battery operated autonomous vehicles that use, e. g., a global navigation/guidance system (e. g., using the GPS or Galileo systems) or an indoor navigation/guidance system (e. g., using induction lines embedded in the lanes or radio beacons). Each vehicle 2c may be provided with a wireless communications system 14a configured to communicate with a communications system 14 of the control system 4. Using the communications systems 14, 14a, each vehicle 2c may transmit its location and status information to the control system 4 and receive travel orders or commands from the control system 4.

Systems that use autonomous vehicles are known, see e. g., Kareem O., Public Transportation on the Era of Autonomous Vehicles: Exploring Different Scenarios. Civil Eng Res J. 2020; 10(5): 555800.DOI: 10.19080/CERJ.2020.10.555800. An autonomous vehicle system is also described in a brochure titled “Autonomous Transport Systems” from ZF Group, Friedrichshafen, Germany. In these contexts, an autonomous vehicle is also referred to as a “pod” or a “podcar”. In one embodiment, the vehicle system 2b may use such autonomous vehicles.

The control system 4 is communicatively coupled to the elevator system 2a and the vehicle system 2c which enables the control system 4 to monitor and control both systems (2a, 2b), and, in particular, to coordinate their operations to serve a passenger's travel request in an optimized way so that a trip meets set travel criteria such as least travel time, shortest distance, solo travel or least number of transfers. In one embodiment, the elevator system 2a and the vehicle system 2c are configured to transmit for each elevator A, B, C, D and each autonomous vehicle 2c its respective status (e. g., available, stand-by, out of service, in use, available transport capacity) and location (e. g., current floor, location on a floor). The status and location information may be stored in a storage device accessible by the control system 4. The control system 4 executes in one embodiment an allocation algorithm that applies one or more cost functions, similar to the above-mentioned allocation algorithm of a destination call control system, to determine a path/travel route (including an elevator and/or a vehicle 2c) that meets one or more of the travel criteria. For that purpose, the allocation algorithm reads the status and location information stored in the storage device.

Furthermore, in one embodiment, the control system 4 may apply any number of path computation techniques, for example, in combination with the allocation algorithm. Example techniques can be similar to those used by software programs that plan travel routes and/or driving directions.

In the embodiment of FIG. 2, the transport system 2 includes a camera system 7 communicatively coupled to the control system 4. The camera system 7 is illustrated by symbols for cameras at various locations within the building 1. For illustrative purposes, only two camera symbols are shown. It is contemplated, however, that the number of cameras and their locations may depend, for example, on the structure of the building 1 and/or the transport system 2. It is further contemplated that the camera system 7 includes hardware and software to control the cameras and to process their recordings. The processing may include detecting the passenger 8, or the robot 9, e. g., in a video recording for tracking purposes (e. g., to determine in which direction a passenger 8 walks, or which elevator car 10 or vehicle 2c the passenger 8 boards, and when), or performing facial recognition for identification and/or authentication purposes (e. g., to determine if the passenger 8 is authorized to use the transport system 8 and/or to access a certain destination). Tracking, identification and/or authentication may also be applied to determine if a passenger 8 follows a certain path/travel route, e. g., if the passenger 8 board the “correct” elevator or vehicle 2c.

In the transport system 2, various interactions and operations can take place, e. g., between the control system 4 and the elevator system 2a and the vehicle system 2b, and between passengers 8 and the transport system 2. Some of the interactions and operations are described in connection with FIG. 3 which shows a block diagram of an exemplary embodiment of the transport system 2 of FIG. 2. In addition to the elevator system 2a, the vehicle system 2b, the call terminals 6, 6a, and the camera system 7, it is indicated in the illustrated embodiment that these components communicate over a network 20 (e. g., a local-area network (LAN), a wide-area network (WAN), a wireless network, the Internet and/or a telephone network) and that the control system 4 includes a trip planning unit 26 and a location and status determining unit 24. The control system 4 is computer-based and configured to execute one or more software programs to perform dedicated functions of the transport system 2, e. g., the function of planning a trip may be assigned to the trip planning unit 26 and the function of determining locations and statuses of the vehicles 2c and elevators A-D may be assigned to the location and status determining unit 24.

FIG. 3 shows further a storage system 22 that stores at least one database. The storage system 22 is communicatively coupled to the control system 4 for read and write operations by the control system 4. The database stores data of a building plan or a building model. The stored data may include a directory of residents and available services (e. g., company names, hotels, restaurants, gyms, and other services or points of interest) within the building 1, including data specifying where they are located (e. g., floor number and office/store/room/apartment number). For each resident or group of residents (e. g., a family or a firm) a passenger profile may be stored in the same or a different database. The stored data may further specify the locations of the elevators A D and the respective distances from the residential locations (e. g., room/apartment number), call terminals 6 and available services. The building plan data may further specify, e. g., locations of doors, security/access gates, escalators, emergency exits or routes, main building entrances, routes and lanes to these locations, and distances between these locations. Areas or zones within the building 1 that are not assigned to a residence or service may be identified by one or more sectors or sector numbers. It is contemplated that the stored building data is provided and available to such a degree of detail that allows planning a route from a place of departure to a destination location. The building data may be updated, e. g., due to changing occupancies or uses, or to reflect current building situations (e. g., constructions, out-of-service elevator cars or vehicles).

In one embodiment, the storage system 22 may include the above-mentioned storage device that stores the status and location information of the transport system 2. As the storage system 22 is in one embodiment communicatively coupled to the control system 4, the control system 4 can access the stored building data and the status and location information, for example, when the trip planning unit 26 is tasked with planning a trip applying the allocation algorithm.

Although FIG. 3 shows a particular arrangement of the components of the transport system 2, wherein some components are depicted as being discrete components, in further embodiments the components may be arranged differently. For example, a single processing unit may perform the functions of the trip planning unit 26 and the function of the location and status determining unit 24. In some embodiments, the components are located in a common location (e. g., in the same room of the building 1). In other embodiments, at least some of the components are located remotely from each other. For example, the trip planning unit 26 can be located remotely from the control system 4 and the associated elevator system 2a. In that case, the trip planning unit 26 can communicate with the control system 4 over one or more networks.

Passengers 8 often use a combination of modes of transportation to reach a destination, for example, because of convenience or necessity (e. g, due to the distance to a destination or a passenger's reduced mobility). While the transport system 2 is configured to transport the passengers 8 in a convenient and efficient way using the elevator system 2a and the vehicle system 2b, there may be other modes of transportation available in the building 1. FIG. 4A shows exemplary transportation modes 30 that can be used by a passenger 8 between a place of departure (origin) and a destination. The additional modes 30 can include, for example, a bicycle, a taxi, an electric scooter, and walking. Possible destinations 40 are shown in FIG. 4B and can include, for example, an airport, a shopping center, a school, an office (e. g., with number), a residence (e. g., with number) and/or a building exit. Depending on the building 1, additional destinations may exist. Other transportation modes and destinations are also possible. These transportation modes 30 and destinations 40 may be presented to a passenger 8 for selection when entering a travel request.

FIG. 5A visually depicts an example of a passenger trip along a timeline (in which time traveled and distance traveled increase from left to right). Beginning at an origin point (depicted on the left-hand side of the figure), a passenger 8 first completes a portion A of the trip, and then completes a portion B of the trip to reach a destination (depicted on the right-hand side of the figure). Portions A and B use different transportation modes. It is contemplated that the passenger trip is not limited to two portions and that a trip may include more than two portions, as shown in FIG. 5C.

FIG. 5B depicts a more specific example of a passenger trip. As indicated by a timeline T, a passenger 8 leaves an office after having entered a travel request using a call terminal 6, 6a and starts a first portion of the trip. In this case, the first portion is an “autonomous vehicle portion,” in which the passenger 8 travels in an autonomous vehicle 2c in horizontal direction from the office to the elevator assigned for transporting the passenger 8 in vertical direction. As indicated by the timeline T, upon completing the autonomous vehicle portion, the passenger 8 is at the elevator and enters the elevator car 10. Thus, the second portion of the passenger trip begins, namely the “elevator portion,” in which the passenger 8 uses the elevator. Upon completion of the elevator portion (e. g., at the destination floor), the passenger has reached the destination floor, or may use another mode of transportation to reach the final destination.

At least some embodiments of the disclosed technologies are not limited to passenger trips such as those specifically appearing in FIGS. 5A and 5B. For example, a passenger trip can comprise an autonomous vehicle portion occurring after the elevator portion, as shown in FIG. 5C, and indicated by the path P in FIG. 2. After entering a travel request to a selected destination, as shown in FIG. 4B, while still in the apartment and having received a travel schedule, the passenger 8 leaves the apartment at the appropriate time and walks to the nearest location on floor L2, where the autonomous vehicle 2c can stop. The autonomous vehicle 2c transports the passenger 8 to the elevator A (Portion A), which then transports the passenger 8 from floor L2 to floor L5 (Portion B). At or near the elevator A on floor L5, another autonomous vehicle 2c is waiting or about to arrive for transporting the passenger 8 to the final destination on floor L5, or to another elevator (Portion C). In various embodiments, any of these three portions can be an elevator portion, and any of the three portions can be an autonomous vehicle portion. Thus, example trips could further include one or more of the transportation modes 30 shown in FIG. 4A.

With the understanding of the components of the transport system 2 described above and their functions, an exemplary method of operating the transport system 2 shown in FIG. 2 is described below in conjunction with FIG. 6. In the situation shown in FIG. 2, the passenger 8 is on the floor L2 and uses a call terminal 6, 6a to enter a travel request that specifies a desired destination within the building 1. Depending on the building, the passenger 8 may be required to present some form of credential when placing a travel request; the credential may be used to verify the passenger's transport and/or access rights. If the call terminal 6 is installed on the floor L2, its location is documented in and available from the building plan. If the call terminal 6a is a mobile phone, it receives according to one embodiment a radio transmission from, e. g., a fixed radio transmitting device (e. g., a sender, transceiver or beacon using a WLAN or a Bluetooth technology) whose location is documented in the building plan; the mobile phone's location is then set as being in proximity of this radio transmitting device. In another embodiment, the passenger 8 may manually enter the location using a graphical user interface provided by a touchscreen of a call terminal 6, 6a (either in its installed terminal configuration or as a mobile phone). An exemplary graphical user interface 60 of a (mobile phone) call terminal 6a is shown in FIG. 7A and FIG. 7B.

The user interface of a call terminal 6, 6a may be configured to display a selection of possible destinations (e. g., as shown in FIG. 4B), e. g., the most recently used destinations or only those the passenger 8 is authorized to access, from which the passenger 8 may select a destination. In another embodiment, the user interface may display a keyboard to allow the passenger 8 to enter the destination. The travel request may be for immediate execution, i. e., the passenger 8 requires transportation at the time of requesting it. Alternatively, the travel request may be set up for execution at a certain time in the future, i. e., the passenger 8 may pre-book or reserve the trip in advance; the transport system 2 can then reserve certain transport modes, e. g., one or more elevators and autonomous vehicles 2c so that they are available without delay at the required time.

The method shown in FIG. 6 begins with a step S1 and ends with a step S9. A person skilled in the art will recognize that the division into these steps is by way of example, and that one or more of these steps may be divided into one or more sub-steps, or that several of the steps may be combined into one step.

In a step S2, a travel request is received. The travel request is received by the control system 4 from the call terminal 6, 6a which the passenger 8 uses to enter the travel request. The travel request specifies the place of departure and the destination.

In a step S3, transport modes are allocated, and trip portions are determined. Using the place of departure, the destination and the building plan data, the trip planning unit 26 of the control system 4 determines one or more possible routes for servicing the travel request. For each route, one or more transport modes (FIG. 4A) may be available at the time and, hence, one or more trip portions can be determined (e. g., FIGS. 5A and 5C). Further, the control system 4, or its trip planning unit 26, respectively, access the storage system 22 to obtain the status and location information. The control system's allocation algorithm uses the available transport modes, the trip portions and the status and location information of the elevator system 2a and the vehicle system 2b to calculate for each possible route a transportation cost value. In one embodiment, the control system 4 is configured to allocate the travel request to that route that has the lowest transportation cost value.

In a step S4, the trip is planned. This includes, for example, creating a travel schedule that lists the place of departure, the transport modes to be used, including estimated times of departure or arrival, and the destination. The listed transport modes may identify the elevator (“A”) or the vehicle 2c (e. g., vehicle name or number). Other or additional information, such as guidance information to or from an elevator or vehicle 2c, may be provided. It is contemplated that the planned trip allows sufficient time for the passenger 8 to transition from one transport mode to the other.

In a step S5, the travel schedule is communicated to the passenger 8. In one embodiment, the travel schedule is displayed at the call terminal 6 used for entering the travel request. An option to print the travel schedule may be available at the call terminal 6. In another embodiment, the travel schedule may be sent to the passenger's mobile phone.

In a step S6, the one or more elevator portions are scheduled. For the transport system 2, the scheduling includes setting operating details for the elevator system 2a. In one embodiment, the operating details specify for each portion, for example, the time (date) and the (departure) floor (L2) at which the allocated elevator (A) has to be available for boarding by the passenger 8. The operating details may further specify the destination floor (L5). The elevator system 2a is configured to execute the one or more elevator portions as scheduled.

In a step S7, the one or more autonomous vehicle portions are scheduled. The scheduling includes setting operating details for the vehicle system 2b. In one embodiment, the operating details specify for each portion, for example, the time (date) and the floor (L2, L5) at which the allocated vehicle 2c has to be available for boarding by the passenger 8. The operating details may further specify the final destination entered by the passenger 8 and/or an intermediate destination, such as the elevator A in FIG. 2. The vehicle system 2a is configured to execute the one or more vehicle portions as scheduled.

In a step S8, the execution of the schedules is monitored. The control system 4 monitors the operation of the elevator system 2a in real time and, hence, can compare the current status of the elevator system 2a with the status it should have according to the scheduled elevator portions. For that purpose, the control system 4 can in one embodiment query the location and status determining unit 24. Similarly, the control system 4 monitors the operation of the vehicle system 2b. In case the control system 4 determines a deviation that negatively affects servicing the travel request, the control system 4 may initiate a mitigating measure (e. g., re-allocate a transport mode) and/or a notification for the passenger 8, e. g., by sending a (push) message to the passenger's mobile phone. The message could advise the passenger 8 that the travel schedule has been modified and include an updated travel schedule.

In addition, the control system 4 may use the camera system 7 to monitor/track the passenger 8 while using the transport system 2. The monitoring may be configured to determine if the passenger 8 uses the transport mode scheduled for that passenger's trip.

For example, the control system 4 may recognize that the passenger 8 boards or is about to board an elevator or vehicle 2c not allocated for the trip, or recognize that the passenger 8 exits the elevator at the wrong floor. In such situations, the control system 4 may cause a notification to be issued to the passenger 8 and/or plan and provide an alternative route for transporting the passenger 8 to the desired destination.

In the illustrated embodiment, the method ends with the step S9.

In a certain embodiment, the passenger's travel request may specify a requested arrival time at the destination. The arrival time can be expressed in terms of a specific time (e. g., “9 AM”) or in terms of a relative time (e. g., “no later than 9 AM,” “in two hours,” “start of last museum tour for today”).

FIG. 7A shows an exemplary embodiment of an electronic device (in this case, a mobile telephone 6a) that can be used in conjunction with the technology described herein. In this particular embodiment, the mobile telephone 6a comprises a touch screen, but other embodiments can use a variety of input devices and output devices. In FIG. 7A, the touch screen displays a graphical user interface 60 with an input area for receiving an end destination of a passenger trip. In the depicted case, the input destination is “OFFICE.” The touch screen also displays an input area for indicating a desired arrival time at the end destination. In the depicted case, the input desired arrival time is “TODAY 9:45 AM.” A passenger can use a button to submit the trip information and reserve the trip. In further embodiments, one or more other user interface elements are used. Additional information can also be provided by the passenger 8 through the call terminal 6a. For example, the passenger 8 can indicate a preferred mode of transportation, how many other people will be traveling with the passenger 8, how much luggage the passenger 8 will bring and/or information about any reminders the passenger 8 wishes to receive prior to departure.

FIG. 7B shows an exemplary embodiment of the mobile telephone 6a after receiving departure information for the passenger trip. The reserved departure times for the passenger trip appear in a display area. In this case, the vehicle 2c is schedule to depart at 9:15 AM. An elevator car assignment appears in a separate display area. In this case, the passenger 8 is assigned to board elevator A that departs at 9:35 AM. Additional information about the trip can also be provided to the passenger 8 through the telephone 6a.

1. An integrated transport system in a building, comprising:
an elevator system having at least one elevator, which has an elevator car and an elevator controller configured to cause the elevator car to move between floors of the building;
a vehicle system having at least one vehicle provided and movable on a floor served by the elevator system, wherein the least one vehicle is configured to serve an elevator hall on the floor; and
a control system communicatively coupled to the elevator system and the vehicle system and configured:
to process a travel request from a call terminal usable for entering the travel request which specifies a place of departure and a destination,
to calculate a trip schedule based on the travel request, the trip schedule involving the elevator system and the vehicle system, and
to control the elevator system and the vehicle system according to the trip schedule.

2. The integrated transport system of claim 1, further comprising a database stored in a storage system configured for read and write operations by the control system, wherein the database stores building plan data, the building plan data specifying for each floor at least locations of at least one of elevator halls, residences, establishments, call terminals, doors, access gates, escalators, emergency exits or routes, and main building entrances, routes and lanes to these locations, and distances between these locations.

3. The integrated transport system of claim 1, wherein the control system includes a location and status determining unit coupled to the elevator system and the vehicle system and configured to determine a location and a status of the at least one elevator and the at least one vehicle

4. The integrated transport system of claim 3, wherein the control system includes a trip planning unit coupled to (i) the location and status determining unit, (ii) the elevator system and (iii) the vehicle system, said trip planning unit configured to compute the trip schedule based on the travel request, a location and status of the at least one elevator, and a location and status of the at least one vehicle determined by the location and status determining unit

5. The integrated transport system of claim 1, wherein the call terminal is installed on a floor and/or is a mobile communications device carried by the passenger or of a robot.

6. The integrated transport system of claim 5, wherein the control system is configured to send the trip schedule to the call terminal from which the control system received the travel request.

7. The integrated transport system of claim 1, further comprising a camera system coupled to the control system and having a plurality of cameras arranged on the floors, wherein the control system is configured
to monitor a movement of a passenger to determine if the passenger is transported according to the trip schedule, and
to generate an alarm signal in the case that a deviation from the trip schedule is detected.

8. The integrated transport system of claim 7, wherein the control system is configured to initiate at least one mitigating measure in response to the alarm signal, wherein the at least one mitigating measure includes generating a notification for being communicated to the passenger, modifying the scheduled trip and/or controlling the elevator system and the vehicle system according to the modified scheduled trip.

9. A method of operating an integrated transport system having an elevator system and a vehicle system which are communicatively coupled to a control system, wherein the elevator system has at least one elevator having an elevator car and an elevator controller configured to cause the elevator car to move between floors of a building, and wherein the vehicle system has a vehicle system having at least one vehicle provided and movable on a floor served by the elevator system wherein the least one vehicle is configured to serve an elevator hall on the floor, the method comprising:
receiving a travel request from a call terminal, the travel request specifying a place of departure and a destination,
calculating a trip schedule based on the travel request, the trip schedule involving the elevator system and the vehicle system, and
controlling the elevator system and the vehicle system according to the trip schedule.

10. The method of claim 9, further comprising reading data of a building plan from a database stored in a storage system the building plan data specifying for each floor at least locations of at least one of elevator halls, residences, establishments, call terminals, doors, access gates, escalators, emergency exits or routes, and main building entrances, routes and lanes to these locations, and distances between these locations, and using the read building plan data for calculating the trip schedule.

11. The method of claim 10, further comprising determining a location and a status of the at least one elevator and the at least one vehicle, and using the location and the status for calculating the trip schedule.

12. The method of claim 9, further comprising sending the trip schedule to the call terminal from which the control system received the travel request.

13. The method claim 9, further comprising:
monitoring a movement of a passenger to determine if the passenger is transported according to the trip schedule using a camera system coupled to the control system and having a plurality of cameras arranged on the floors, and
generating an alarm signal in case a deviation from the trip schedule is detected.

14. The method of claim 13, further comprising initiating at least one mitigating measure in response to the alarm signal, wherein the at least one mitigating measure includes generating a notification for being communicated to the passenger, modifying the scheduled trip and/or controlling the elevator system and the vehicle system according to the modified scheduled trip.
